(19) United States
(12) Patent Application Publication
(10) Pub. No.: US 2025/0278140 A1
(43) Pub. Date: Sep. 4, 2025

(54) SYSTEM FOR HAPTIC FEEDBACK

(71) Applicant: Brian Schmidt, Galena, OH (US)

(72) Inventor: Brian Schmidt, Galena, OH (US)

(21) Appl. No.: 19/070,384

(22) Filed: Mar. 4, 2025

Related U.S. Application Data
(60) Provisional application No. 63/561,039, filed on Mar. 4, 2024.

(51) Int. Cl. G06F 3/01; G06F 1/16

(52) U.S. Cl. CPC G06F 3/016; G06F 1/16; G06F 3/011

(57) ABSTRACT

Disclosed is a wearable apparatus for positioning haptic devices that is modular, light weight, inexpensive, and formfitting even when a user's body moves or rotates. The wearable apparatus for positioning haptic devices includes bindings that are wrappable around a body part and a plurality of spacers attached to the bindings. Each bindings include an elastic member and at least one support member connected to, and holdable in place by, the elastic member. Each support member provides a structure for incorporating a haptic device, either by attachment or integration. Also disclosed is a wearable apparatus for generating tactile stimuli which includes the wearable apparatus for positioning haptic devices, in addition to at least one haptic device incorporated with a support member thereof.

### CROSS-REFERENCE TO RELATED APPLICATIONS

This application is a nonprovisional patent application that makes a priority claim to U.S. Provisional Application No. 63/561,039, filed on Mar. 4, 2024, which is hereby incorporated by reference in its entirety as if fully recited herein.

### FIELD

The application relates to haptics for virtual and augmented reality applications and, more particularly, to wearable apparatus for positioning haptic devices on a user's body and wearable apparatus for producing haptic stimuli.

### BACKGROUND

Devices, apparatus, systems, and the like related to virtual and augmented reality have been the subject of much development. In general, there is a desire to improve or enhance the immersive quality of virtual and augmented reality experiences.

One way to improve or enhance the immersiveness of a virtual reality experience is to simulate the sensation of touch. Towards that end, many devices have been developed to provide for haptic stimulation on the body. These devices generally incorporate a plurality of haptic devices and provide a means for arranging those haptic devices on the body of a user (gloves, suits, etc.). Skilled artisans will appreciate, however, that there are significant design challenges related to such devices given that: a) the devices may be worn for long periods of time, making them susceptible to the buildup of dirt, grime, and body odor; and b) the devices must reliably maintain the placement and spacing of haptic devices, as well as contact between the haptic devices and the user, even as the user moves or rotates his/her body or his/her body changes (e.g., due to weight loss or growing into adulthood).

The current solutions for positioning haptic devices on the body of a user by-and-large fail to meet all of the following requirements: light weight; comfortable; form-fitting in all directions even when the user's body moves, rotates, or changes in size and shape; capable of maintaining a desired amount of pressure against the body; resistant to body odor and perspiration; easily removable; and inexpensive. Accordingly, those skilled in the art continue with research and development efforts in the field of haptic devices, apparatus, and systems.

### SUMMARY OF THE INVENTION

Disclosed are wearable apparatus for positioning haptic devices and wearable apparatus for producing haptic stimuli.

Embodiments of the wearable apparatus for positioning haptic devices generally include a first binding that includes a first elastic member that is wrappable around a body part and at least one support member connected to the first elastic member; wherein the first elastic member presses each connected support member against a body part when it is wrapped around a body part; and wherein each connected support member of the first binding includes an incorporating means for incorporating a haptic device.

In some embodiments of the wearable apparatus for positioning haptic devices, the wrappable apparatus further includes a second binding that includes a second elastic member that is wrappable around a body part and at least one support member connected to the second elastic member; wherein the second elastic member presses each connected support member against a body part when it is wrapped around a body part; and wherein each connected support member of the second binding includes an incorporating means for incorporating a haptic device. In some of these embodiments, the apparatus further includes a spacer connected to a support member of the first binding and a support member of the second binding; wherein the spacer establishes a fixed distance between the first binding and the second binding when the first and second bindings are wrapped around a body part; and wherein the spacer includes at least one of: a piece of fixed-length tubing and a wire extending through the tubing; a fixed-length rod; and an adjustable-length rod. In some these embodiments, the apparatus includes a first support member and a second support member, both connected to the first elastic member; moreover, the apparatus further includes a third support member connected to the second elastic member; wherein the first support member is spaced apart from the second support member along the first elastic member; and wherein the third support member is positioned in-between the first support member and the second support member. In some of these embodiments, the apparatus further includes at least one of: a first spacer connected to the first support member and the third support member; and a second spacer connected to the second support member and the third support member; wherein the first spacer and the second spacer, either individually or collectively, establishes a fixed distance between the first binding and the second binding when the first and second bindings are wrapped around a body part. In some of these embodiments, the apparatus includes a first support member and a second support member, both connected to the first elastic member; and further includes a third support member and a fourth support member, both connected to the second elastic member. In some of these embodiments, the apparatus further includes at least one of: a first spacer connected to the first support member and the third support member; and a second spacer connected to the second support member and the fourth support member; wherein the first spacer and the second spacer, either individually or collectively, establishes a fixed distance between the first binding and the second binding when the first and second bindings are wrapped around a body part.

In some embodiments of the wearable apparatus for positioning haptic devices, the elastic member includes at least one of an elastic strip, an elastic band, and a tension spring.

In some embodiments of the wearable apparatus for positioning haptic devices, a support member of the first binding includes: a body that includes plurality of peripheral loops; and the elastic member is threaded through a peripheral loop of the support member, thereby connecting the support member to the first elastic member.

In some embodiments of the wearable apparatus for positioning haptic devices, a support member of the first binding includes: a body that defines a face, wherein the face is orientated towards a body part when the first elastic member is wrapped around a body part; and the incorporating means of the support member is provided on the face and includes at least one of: an adhesive; and a plurality of protrusions extending from the face for receiving a haptic device in a friction fit.

In some embodiments of the wearable apparatus for positioning haptic devices, the apparatus further includes a second binding that includes: a second elastic member that is wrappable around a body part as well as a third support member and a fourth support member, both connected to the second elastic member; wherein: the third support member is spaced apart from the fourth support member along the second elastic member; the second elastic member presses each connected support member against a body part when it is wrapped around a body part; and the third support member and the fourth support member each includes a means for incorporating a haptic device. In these embodiments, the wearable apparatus further includes a third binding that includes: a third elastic member that is wrappable around a body part and a fifth support member connected to the third elastic member; wherein: the third elastic member is positioned in-between the first elastic member and the second elastic member; the third elastic member presses each connected support member against a body part when it is wrapped around a body part; and the fifth support member includes a means for incorporating a haptic device. In these embodiments, the wearable apparatus further includes: a first spacer connected to the first support member of the first binding and the third support member of the second binding; and a second spacer connected to the second support member of the first binding and the fourth support member of the second binding. In these embodiments, the first spacer and the second spacer collectively establish a fixed distance between the first binding and the second binding when the first and second bindings are wrapped around a body part; due to the support member spacing in the first binding and the second binding, a gap is defined between the first spacer and the second spacer; and the fifth support member is positioned in the gap between the first spacer and the second spacer.

Embodiments of the wearable apparatus for producing haptic stimuli generally include a wearable apparatus for positioning haptic devices, such as any of the embodiments describe above, and further includes at least one haptic device incorporated into a support member thereof. In these embodiments, the haptic device(s) may include at least one of: vibrotactile motors, electro-stimulation devices, waterjet devices, static electricity devices, and piston pushers.

Other examples of the disclosed wearable apparatus for positioning haptic devices and wearable apparatus for producing haptic stimuli will become apparent from the following detailed description, the accompanying drawings and the appended claims.

### BRIEF DESCRIPTION OF THE DRAWINGS

FIG. 1 is a perspective view of an embodiment of a wearable apparatus for positioning haptic devices being worn by a user;

FIG. 2 is a perspective view of the embodiment of FIG. 1 being worn by a user with his forearm rotated;

FIG. 3 is a top view of the embodiment of FIG. 1;

FIG. 4 is a top view of a representative section of the embodiment of FIG. 1;

FIG. 5 is a top view of a section of an embodiment of a wearable apparatus for producing haptic stimuli which utilizes the embodiment of FIG. 1;

FIG. 6 is a top view of an embodiment of a support member, a bottom view of another embodiment of a support member, and front view of an embodiment of a stopper;

FIG. 7 is a side view of the embodiment of the stopper of shown in FIG. 6 being inserted into a support member;

FIG. 8 is a side view of the embodiment of the stopper of shown in FIG. 6 that was inserted into a support member;

FIG. 9 is a side view of an embodiment of an accessory component being attached to a support member;

FIG. 10 is a side view of the embodiment of an accessory component shown in FIG. 9 that has been attached to a support member; and

FIG. 11 is an illustration of an embodiment of a support member.

### DETAILED DESCRIPTION

The following detailed description refers to the accompanying drawings, which illustrate specific examples described by the disclosure. Other examples having different structures and operations do not depart from the scope of the present disclosure. Like reference numerals may refer to the same feature, element, or component in the different drawings.

Illustrative, non-exhaustive examples, which may be, but are not necessarily, claimed, of the subject matter according the present disclosure are provided below. Reference herein to “example” means that one or more feature, structure, element, component, characteristic and/or operational step described in connection with the example is included in at least one embodiment and/or implementation of the subject matter according to the present disclosure. Thus, the phrase “an example” and similar language throughout the present disclosure may, but do not necessarily, refer to the same example. Further, the subject matter characterizing any one example may, but does not necessarily, include the subject matter characterizing any other example.

One aspect of the present invention relates to a wearable apparatus for positioning haptic devices on a person's body. As used herein, the term “haptic device” refers to devices which are capable of producing haptic stimuli perceivable by humans; some examples include vibrotactile motors, electro-stimulation devices, waterjet devices, static electricity devices, and piston pushers. The wearable apparatus provides a way for a person to effective “wear” the haptic devices and ensures that the haptic devices are correctly positioned when worn, even as the user moves his/her body. This allows the haptic devices to create specific patterns of haptic stimuli which can be manipulated to simulate various types of touch, e.g., rain drops on skin, catching a ball, being struck by another person, etc.

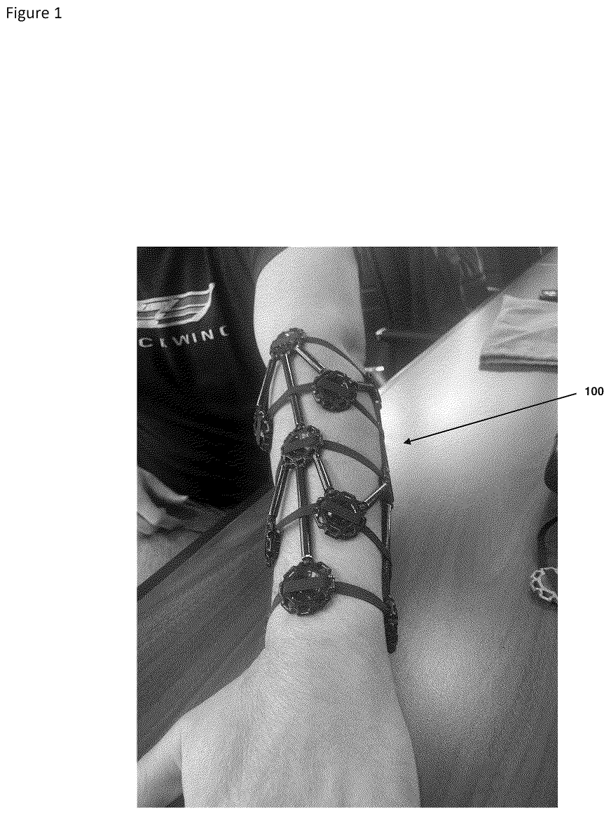

Depicted in FIGS. 1-3 is a wearable apparatus for positioning haptic devices 100 according to an example embodiment. Wearable apparatus 100 includes five bindings 10 and a plurality of spacers 20, wherein each of the five bindings 10 includes an elastic member 12 and three support members 18. The support members 18 provide a support structure for incorporating haptic devices, either by attachment or integration. Each support member 18 is connected to an elastic member 12 which is wrappable around a body part; the elastic members 12 serve as a means for holding the support members 18 in place. The spacers 20 are connected to each binding 10 (preferably, to a support member thereof) and help to establish a fixed distance between the bindings 10 when they are wrapped around (and secured to) a body part (i.e., worn by the user). In view of FIGS. 1-3, it can be appreciated that various arrangements of haptic devices can be achieved through the use of spacers 20 and the selective positioning of support members 18 along the elastic members 12.

Other embodiments of the wearable apparatus are not limited to any particular number of bindings nor any particular number of support members for each binding; more or less of either may be utilized without departing from the scope of the present disclosure. Similarly, other embodiments of the wearable apparatus are not limited to any particular arrangement of spacers, though the arrangements described herein are preferred.

It can be appreciated that wearable apparatus 100 is generally modular in nature, given that bindings, spacers, and support members can be added or removed as needed. This facilitates greater, yet quite easy customization of wearable apparatus for different users and different applications.

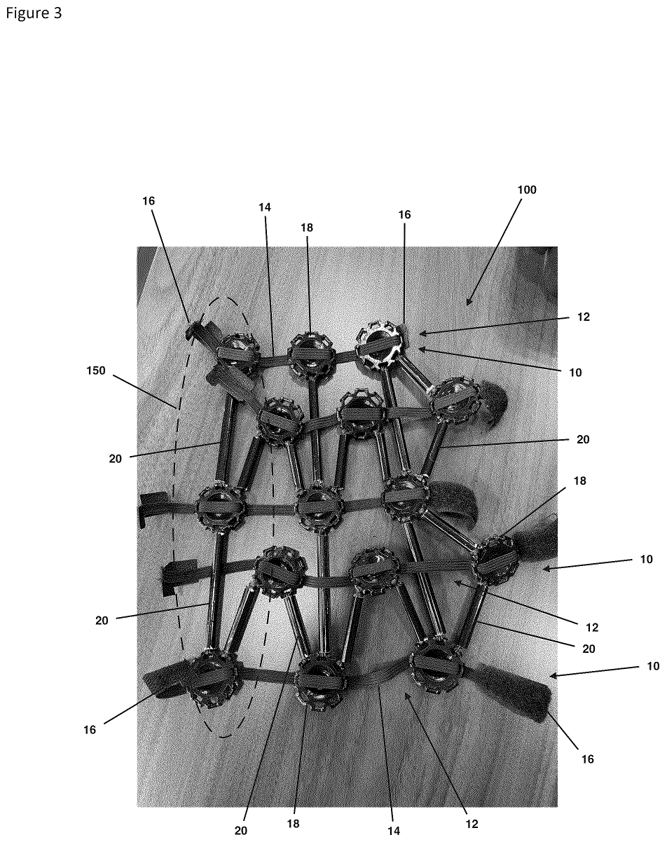

Referring to FIG. 3, each elastic member 12 of wearable apparatus 100 includes a linear elastic strip 14 with corresponding hook-and-loop fasteners 16 (Velcro) attached to their opposing ends. These elastic strips 14 may be wrapped around a body part and secured closed by engaging their respective fasteners 16. Upon doing so, tension is created in the elastic strips 14 which causes them to push against the support members 18, thereby pressing them into the body part and holding them in place. The elastic strips 14 may be of any suitable length and material composition (through sweat and odor resistant materials are preferred) provided that there is sufficient tension in the elastic strips 14 such that each connected support member 18 is reasonably secure when the respective elastic member 12 is wrapped around a body part (preferably without being uncomfortably tight).

Other embodiments of the wearable apparatus may utilize different types of elastic members such as, for example, linear tension springs. Other embodiments may also utilize a closed, loop-type elastic member rather than an open (but closable) linear elastic member; for example, support members may be connected to an elastic band rather than an elastic strip, and the elastic band may be wrapped around a body part by having the user insert his/her body part through it. Further, other embodiments may utilize multiple elastic strips to connect support members rather than a single elastic strip that all the support members are connected to; for example, multiple elastic strips may be utilized to connect each support member in sequence (with each elastic strip connected on opposite ends to a support member) such that a closed loop is formed of alternating support members and elastic strips.

Where applicable, other embodiments of the wearable apparatus are not limited to any particular means for closing elastic members; different types of closing means (besides hook-and-loop fasteners) such as snap fasteners, twist-lock fasteners, magnetic fasteners, and the like may be utilized without departing from the scope of the present disclosure.

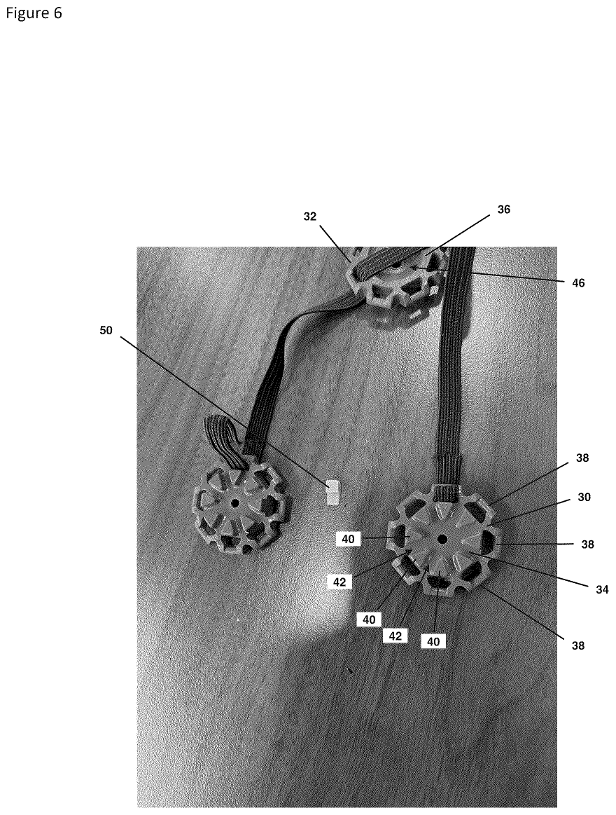

Depicted in FIG. 6 is support member 30 and support member 32, both of which are in accordance with an example embodiment and are representative of the other support members depicted in the Figures, including FIGS. 1-3. As shown, support members 30 and 32 have a generally disc-shaped body that comprises a first major side (ref. no. 34), a second major side (ref. no. 36), and a plurality of peripheral loops (ref. no. 38) radially disposed along the peripheral edges thereof. Support members 30 and 32 may be connected to an elastic member by threading the elastic member (which may be an elastic strip) through one or more of their peripheral loops 38. In preferred embodiments, the elastic member may be connected to support members in the manner shown in FIG. 3, i.e., threaded through two diametrically opposed peripheral loops of a support member while extending overtop the second major side thereof; this arrangement ensures that the first major side of the support member is oriented towards the body and also allows the support member to slide along the elastic member for easy repositioning.

There is an intended symbiotic relationship between the width and thickness of the elastic strip, and the design choice of peripheral loops. As the elastic stretches, it gets slimmer, allowing it to slip more easily through a peripheral loop. Therefore, when the full apparatus is put on and stretching forces are applied throughout, the elastic strip across support members quickly reaches an equilibrium of tension, as a higher tension area will slip easier taking up slack in all available directions. This evens tension throughout, and the now-wider elastic applies more perpendicular pressure to the sides of the peripheral loops such that the support member maintains in a semi-locked position on the elastic strip.

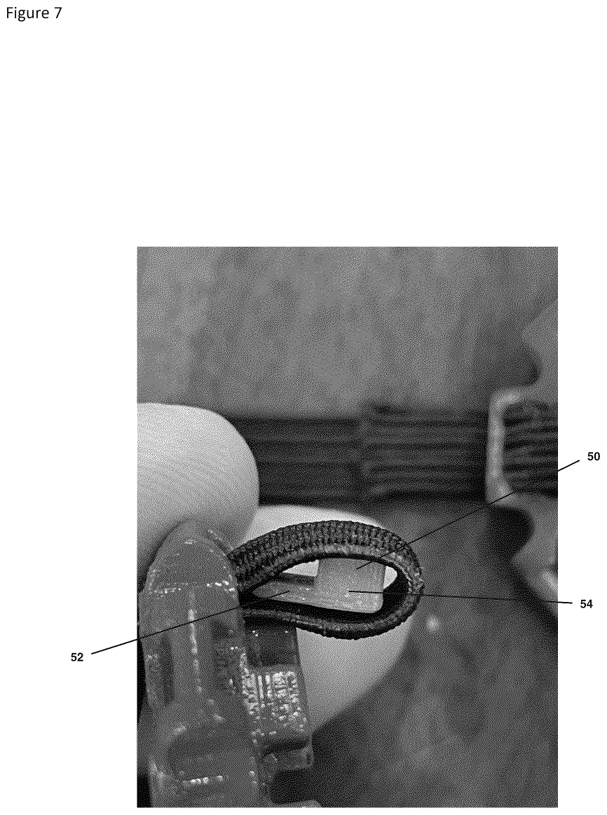

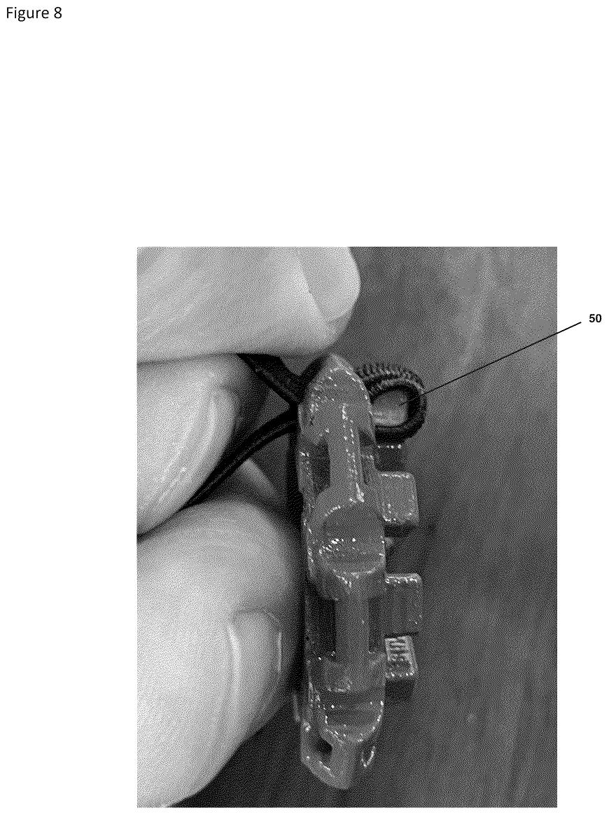

Depicted in FIGS. 6-8 is stopper 50, which is in accordance with an example embodiment. Stopper 50 is a small, wedge-like structure comprising a relatively thick portion 54 and a relatively thin portion 52. As shown in FIGS. 7-8, the stopper 50 can be inserted into a fold made in an elastic strip which has been inserted through a peripheral loop of a support member; by pulling on the elastic strip the thin portion 52 of the stopper 54 will be inserted into the peripheral loop until stopped by the thick portion 54, which prevents the support member from sliding along the elastic strip.

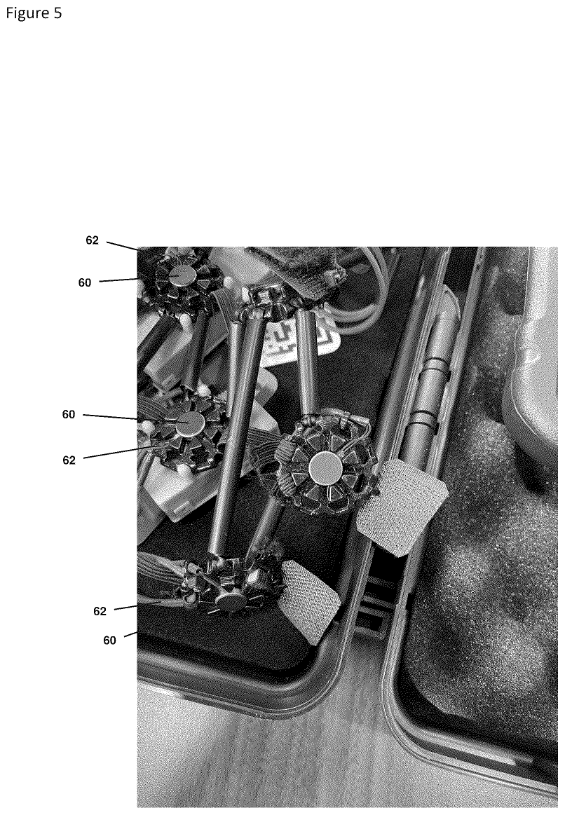

Referring to FIG. 6, the first major side 34 of support member 30 (also referred to as a “face”) is substantially planar and includes a plurality of protrusions 40 extending therefrom. These protrusions 40 are generally triangular and are provided in spaced circular arrangement, with each protrusion 40 pointing towards the center, and with gaps 42 defined in-between each protrusion 40. As shown in FIG. 5, these protrusions 40 collectively function as an incorporating means for incorporating (by attachment) a haptic device 60 in a friction fit (in this case, a small disc-shaped vibrotactile motor), whereas the gaps 42 in-between the protrusions 40 provide space for wires 62 associated with the haptic device to be threaded. Additionally, the gaps 42 also allow for some airflow along the first major side 34 which can be helpful for cooling purposes. There is also a center through-hole defined in the body of support member 44 which extends between the first and second major sides 34, 36 thereof; the center through-hole 44 provides further space for wiring and/or airflow.

It is noted that the second major side 36 of support member 32 defines a recess 46 in the center. This recess 46 reduces the amount of fabrication material needed and therefore also reduces the overall weight and cost of support member 32.

In other embodiments of the wearable apparatus, the support members are not limited to any particular size or shape, nor any particular incorporating means for haptic devices, nor any particular connecting means for elastic members. These aspects of the wearable apparatus, either individually or in combination, may vary without departing from the scope of the present disclosure. In some embodiments, attachment means for the elastic members may include mechanical fasteners and adhesives (either in addition to or as an alternative for the peripheral loops). It is preferred that the attachment means for the elastic members provide for at least some freedom of motion for the support members.

In some embodiments of the wearable apparatus, the incorporating means of a support member may include a recess defined in the body thereof for receiving at least part of haptic device in a friction fit. In some embodiments of the wearable apparatus, the incorporating means of a support member may include a cavity defined within in the body thereof wherein a haptic device may be received and completely enclosed. In some embodiments of the wearable apparatus, the incorporating means of a support member may include adhesives provided on the first major side and/or elsewhere.

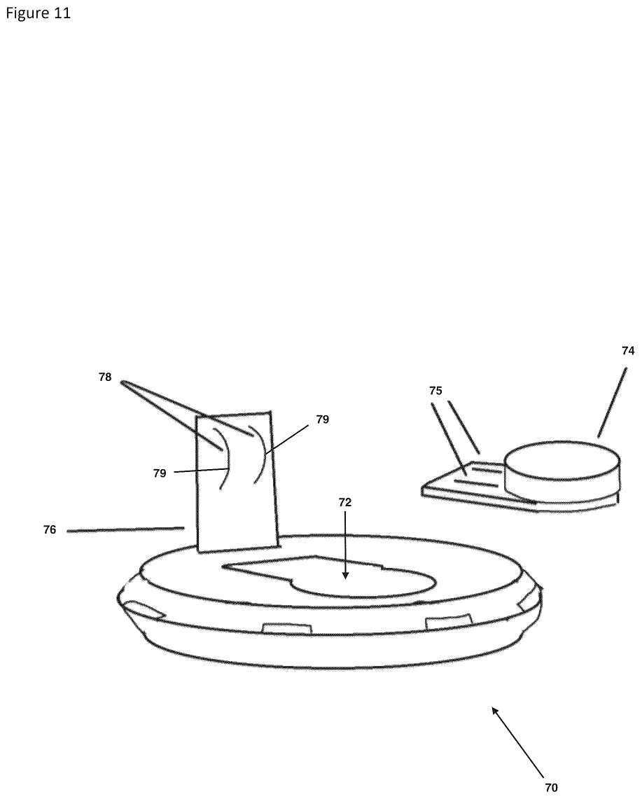

Depicted in FIG. 11 is another support member 70 in accordance with an example embodiment. This support member 70 includes a body that defines an internal cavity 72 wherein a vibrotactile motor 74 may be received and enclosed. Skilled artisans will appreciate that vibrotactile motors of this variety typically include protruding contact pads 75 (depicted in FIG. 13 as a planar portion underneath a disc-shaped motor) where wires would normally be soldered. The support member 70 also includes a door 76 for accessing (i.e., opening or closing) the internal cavity 72. Incorporated into the door 76 are spring clips 78 which comprise a conductive metal material composition (preferably copper) and an interior portion 79 which extends towards the internal cavity 72. When a vibrotactile motor 74 is inserted into the internal cavity 72 and the door 76 is closed, the interior portion 79 of the spring clips 78 will contact the vibrotactile motor 74. Rather than soldering wires directly to the contact pads 75 of the vibrotactile motor 74, the wires may instead be soldered to spring clips 78 (preferably though door 76 or along the exterior side of door 76). This allows the spring clips 78 to function as transmission means for actuation/control signals to the motor 74, which, in turn, allows for thicker, more durable wires to be used (since they don't have to be threaded through narrow gaps) and for easier replacement of motors if/when they burn out (since the user would not have to solder wires).

Referring to FIG. 3, wearable apparatus 100 includes a plurality of spacers 20 to help establish fixed distances between bindings 10 when the bindings 10 are wrapped around a body part (i.e., worn). In this embodiment, the spacers 20 comprise a plurality of fixed-length rods which are each attached on their opposing ends (via a mechanical fastening) to support members 18 of different bindings 10. As shown, fixed-length rods of varying lengths are used (more on this below).

Embodiments of the wearable apparatus are not limited to spacers of any particular size, shape, or means for attaching, provided that a fixed distance between bindings can be established (and preferably, at least some freedom of motion for the support members). In some embodiments, the spacers may include length adjustment mechanisms such as turnbuckles to accommodate different support member arrangements or different sized users. In some embodiments, the spacers may include an elastic member inserted through a fixed-length section of tubing; the elastic member may be attached to different support members while in a state of tension, thereby pulling them against the tubing. In some embodiments, the spacers may include a non-elastic piece of wire inserted through a fixed-length section of tubing, with the piece of wire attached to different support members; the length of the wire between support members is easily adjustable by adding or taking away slack.

Depicted in FIG. 5 is a representative section of wearable apparatus 100 which is helpful for showing the main design elements thereof. This section includes bindings 110, 120, and 130. Binding 110 includes support members 114 and 116 both connected to elastic member 112. Binding 120 includes support member 124 which is connected to elastic member 122. Binding 130 includes support members 134 and 136, both connected to elastic member 132. This section further includes spacer 142 which is connected to support members 114 and 134; spacer 144 which is connected to support members 116 and 136; spacer 146 which is connected to support members 114 and 124; and spacer 148 which is connected to support members 116 and 124.

Bindings 110 and 120 are positioned such that elastic members 112 and 122 are oriented parallel to one another and support members 114, 116, and 124 collectively define a triangular arrangement. This triangular arrangement is maintained by spacers 146 and 148 which are of equal length.

Bindings 110 and 130 are positioned such that elastic members 112 and 132 are oriented parallel to one another and support members 114, 116, 134, and 136 collectively define a rectangle arrangement. This rectangular arrangement is maintained by spacers 142 and 144 which are of equal length.

It can be appreciated that due to the length of the spacers, support member 124 is positioned proximate (i.e., at or near) the center of the rectangular arrangement defined by support members 114, 116, 134, and 136, resulting in additional triangular arrangements being defined between support member 124 and the other sides of the rectangular arrangement.

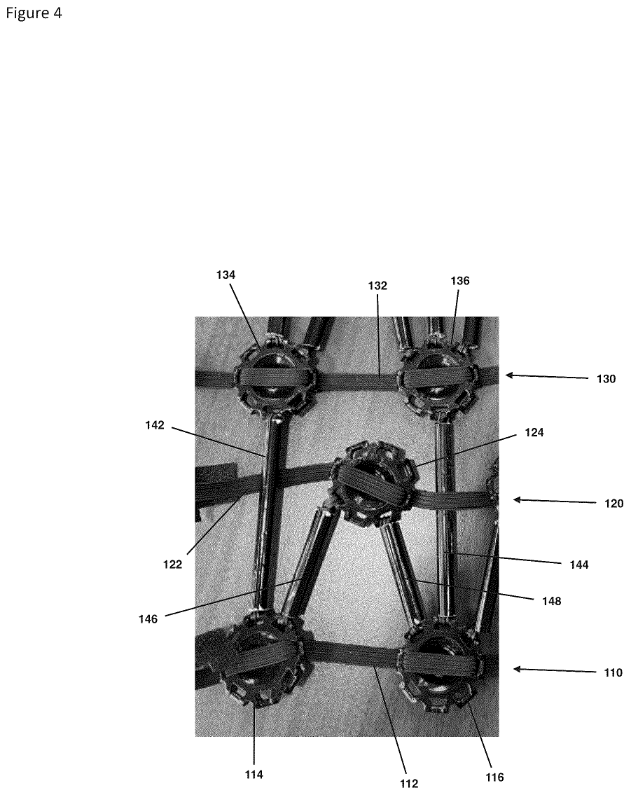

Referring to FIG. 4, the result of repeating the rectangular arrangement along the same bindings and across additional bindings is the formation of a generally sheet-like structure having linear rows of spacers 150. This sheet-like structure is of substantially fixed length in one dimension (along the spacers) but remains flexible in another dimension (along the elastic members).

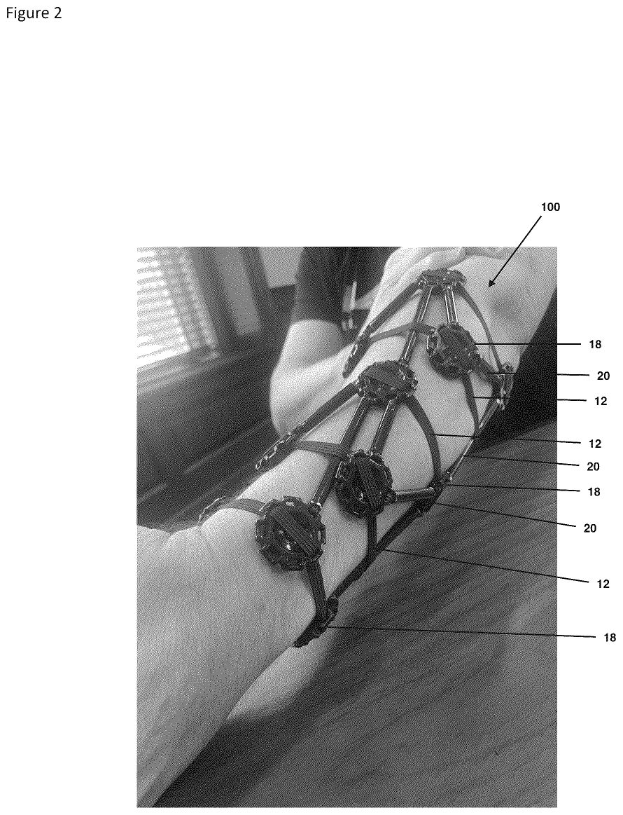

Referring to FIGS. 1 and 2, wearable apparatus 100 was designed to be worn around a person's forearm, which has unique considerations. For one, forearms include a generally linear bone structure (consisting of the radius bone and the ulna bone) of fixed length. However, the thickness of a forearm can change in certain points when the person moves or flexes (e.g., becoming thicker in the muscle proximate the elbow). Furthermore, hand rotation about the wrist involves turning the forearm which can affect the positioning of disc members (see FIGS. 1 and 2). Skilled artisans would appreciate that these unique considerations are also applicable to other body parts such as the upper arm, the upper leg, and the lower leg.

Wearable apparatus 100 can accommodate the considerations described above given that:
A. the linear rows of spacers 150 in wearable apparatus 100 ensures that the support members 18 they are attached to are oriented parallel to the bone structure and separated from one another by a substantially equidistant extent, thereby ensuring an even distribution of support members 18 across a length of a fixed-length body part;
B. the flexible nature of the elastic members 12 of the bindings 10 allows the sheet-like structure to expand or retract as needed to account for changes in thickness caused by any flexing or movement of the body part; and
C. the support members 18 located in-between the linear rows of spacers 150 (proximate the center of the rectangular arrangements) are able to move, at least to some extent, independently of said rows 15 which allows those support members 18 to essentially “float” across a body part as it rotates (best shown in FIGS. 1 and 2), thereby preventing those support members 18 from inadvertently tilting/rising up in some areas and ensuring a consistent degree of contact with the user.

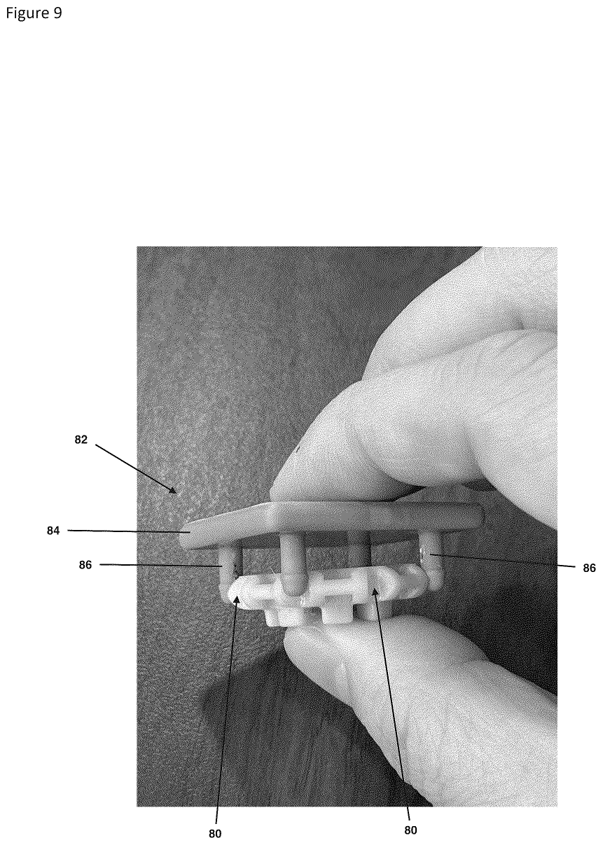

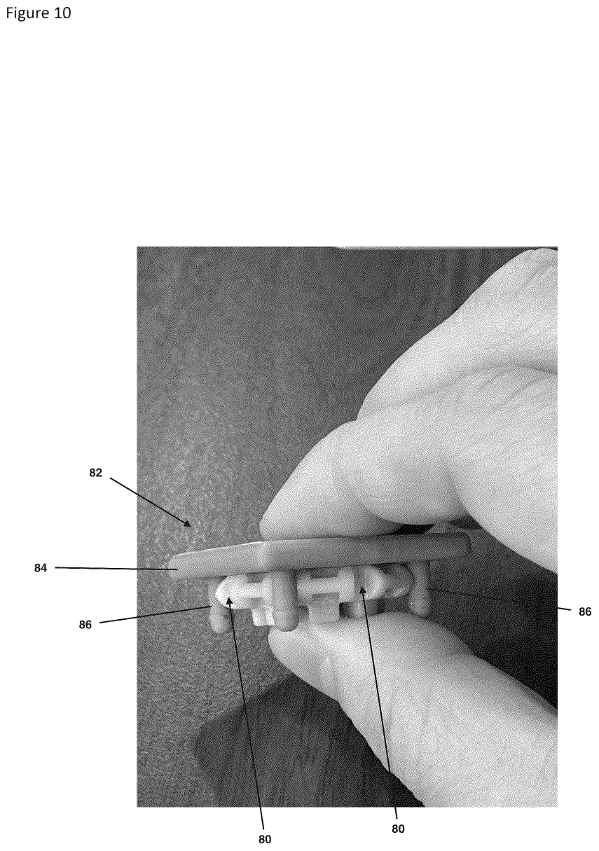

Referring to FIGS. 9 and 10, the peripheral loops of a support member may define slots 80 therebetween that allow accessory components to be attached. Accessory component 82 includes a main body 84 and a plurality of prongs 86 extending therefrom. The main body 82 may be utilized as a structure for attaching various items, such as for decorative or utilitarian purposes. The prongs 86 are slot table into the slots 80 defined between the peripheral loops of a support member and enable the accessory component 82 to attach to a support member in a snap fit. Accessory component 82 is intended to be representative of other types of accessory components that may be attached.

Another aspect of the present invention relates to a wearable apparatus for producing haptic stimuli. Embodiments of the wearable apparatus producing haptic stimuli include the wearable apparatus for positioning haptic devices described above, but further includes one or more haptic devices incorporated into the support members thereof (such as in the manner shown in FIGS. 7 and 13). The haptic devices utilized are preferably inexpensive, lightweight, resistant to overheating, and energy efficient. Embodiments of the wearable apparatus for producing haptic stimuli are not limited to any particular type of haptic device, however haptic devices such as vibrotactile motors, electro tactile rending devices, and a fluid tactile rendering device are generally preferred.

Embodiments of the wearable apparatus for positioning haptic devices and embodiments of the wearable apparatus for generating haptic stimuli are at least useful for virtual reality applications as a way of recreating or simulating the sensation of touch experienced by a virtual reality character (existing in a digital environment) on a person in real-life (namely, a person playing as the virtual reality character). It is contemplated that the wearable apparatus may help to improve or otherwise facilitate a sense of immersion in virtual reality environments.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A wearable apparatus comprising:
a first binding comprising:
a first elastic member that is wrappable around a body part; and
at least one support member connected to the first elastic member;
wherein the first elastic member presses each connected support member against a body part when it is wrapped around a body part; and
wherein each connected support member of the first binding comprises an incorporating means for incorporating a haptic device.

2. The apparatus of claim 1, further comprising:
a second binding comprising:
a second elastic member that is wrappable around a body part; and
at least one support member connected to the second elastic member;
wherein the second elastic member presses each connected support member against a body part when it is wrapped around a body part; and
wherein each connected support member of the second binding comprises an incorporating means for incorporating a haptic device.

3. The apparatus of claim 2, further comprising:
a spacer connected to a support member of the first binding and a support member of the second binding;
wherein the spacer establishes a fixed distance between the first binding and the second binding when the first and second bindings are wrapped around a body part;
wherein the spacer comprises at least one of:
a piece of fixed-length tubing and a wire extending through the tubing;
a fixed-length rod; and
an adjustable-length rod.

4. The apparatus of claim 2, wherein:
the apparatus comprises a first support member and a second support member, both connected to the first elastic member;
the first support member is spaced apart from the second support member along the first elastic member;
the apparatus further comprises a third support member connected to the second elastic member; and
the third support member is positioned in-between the first support member and the second support member.

5. The apparatus of claim 4, further comprising at least one of:
a first spacer connected to the first support member and the third support member; and
a second spacer connected to the second support member and the third support member;
wherein the first spacer and the second spacer, either individually or collectively, establishes a fixed distance between the first binding and the second binding when the first and second bindings are wrapped around a body part.

6. The apparatus of claim 2, wherein:
the apparatus comprises a first support member and a second support member, both connected to the first elastic member; and
the apparatus further comprises a third support member and a fourth support member, both connected to the second elastic member.

7. The apparatus of claim 6, further comprising at least one of:
a first spacer connected to the first support member and the third support member; and
a second spacer connected to the second support member and the fourth support member;
wherein the first spacer and the second spacer, either individually or collectively, establishes a fixed distance between the first binding and the second binding when the first and second bindings are wrapped around a body part.

8. The apparatus of claim 1, wherein:
the elastic member comprises at least one of an elastic band and a tension spring.

9. The apparatus of claim 1, wherein:
a support member of the first binding comprises:
a body that comprises plurality of peripheral loops; and
the elastic member is threaded through a peripheral loop of the support member, thereby connecting the support member to the first elastic member.

10. The apparatus of claim 9, further comprising:
a wedge piece insertable into a peripheral loop of the support member, configured to lock the position of the support member relative to the first elastic member.

11. The apparatus of claim 1, wherein:
the elastic member is a linear elastic member; and
the linear elastic member comprises a loop-opening/closing feature on opposing linear ends thereof.

12. The apparatus of claim 1, wherein:
a support member of the first binding comprises:
a body that defines a face, wherein the face is orientated towards a body part when the first elastic member is wrapped around a body part; and
the incorporating means of the support member is provided on the face and comprises at least one of:
an adhesive; and
a plurality of protrusions extending from the face for receiving a haptic device in a friction fit.

13. The apparatus of claim 12, wherein:
the incorporating means comprises a plurality of radial protrusions; and
at least two of the radial protrusions are spaced apart from one another such that a gap is defined therebetween.

14. A wearable apparatus for producing haptic stimuli, the apparatus comprising:
the apparatus of claim 1; and
a haptic device incorporated with at least one support member of the apparatus of claim 1.

15. The apparatus of claim 14, wherein:
the haptic device comprises at least one of:
a vibrotactile motor;
an electro tactile rending device; and
a fluid tactile rendering device.

16. A wearable apparatus comprising:
a first binding comprising:
a first elastic member that is wrappable around a body part; and
a first support member and a second support member, both connected to the first elastic member;
wherein:
the first support member is spaced apart from the second support member along the first elastic member;
the first elastic member presses each connected support member against a body part when it is wrapped around a body part; and
the first support member and the second support member each comprises an incorporating means for incorporating a haptic device;
a second binding comprising:
a second elastic member that is wrappable around a body part; and
a third support member and a fourth support member, both connected to the second elastic member;
wherein:
the third support member is spaced apart from the fourth support member along the second elastic member;
the second elastic member presses each connected support member against a body part when it is wrapped around a body part; and
the third support member and the fourth support member each comprises an incorporating means for incorporating a haptic device;
a third binding comprising:
a third elastic member that is wrappable around a body part; and
a fifth support member connected to the third elastic member;
wherein:
the third elastic member is positioned in-between the first elastic member and the second elastic member;
the third elastic member presses each connected support member against a body part when it is wrapped around a body part; and
the fifth support member comprises an incorporating means for incorporating a haptic device;
a first spacer connected to the first support member of the first binding and the third support member of the second binding; and
a second spacer connected to the second support member of the first binding and the fourth support member of the second binding;
wherein:
the first spacer and the second spacer collectively establish a fixed distance between the first binding and the second binding when the first and second bindings are wrapped around a body part;
due to the support member spacing in the first binding and the second binding, a gap is defined between the first spacer and the second spacer; and
the fifth support member is positioned in the gap between the first spacer and the second spacer.

17. The apparatus of claim 16, further comprising:
a third spacer connected to the first support member and the fifth support member; and
a fourth spacer connected to the second support member and the fifth support member;
wherein the third spacer and the fourth spacer collectively establish a fixed distance between the first binding and the third binding when the first and third bindings are wrapped around a body part.

18. The apparatus of claim 16, wherein:
the third elastic member wraps around the first spacer and the second spacer when the third elastic member.

19. A wearable apparatus for producing haptic stimuli, the apparatus comprising:
the apparatus of claim 16; and
a haptic device incorporated with at least one support member of the apparatus of claim 16.
